(19) United States
(12) Patent Application Publication
(10) Pub. No.: US 2017/0098244 A1
(43) Pub. Date: Apr. 6, 2017

(54) METHODS AND APPARATUSES FOR RETARGETING WEB USERS WITHIN AFFILIATED CONTENT RECOMMENDATION NETWORK

(71) Applicant: RevContent, LLC, Sarasota, FL (US)

(72) Inventors: Chris Maynard, Sarasota, FL (US); Aziz Hussain, Sarasota, FL (US); John Daniel Lemp, Sarasota, FL (US)

(73) Assignee: RevContent, LLC, Sarasota, FL (US)

(21) Appl. No.: 15/280,924

(22) Filed: Sep. 29, 2016

Related U.S. Application Data
(60) Provisional application No. 62/236,104, filed on Oct. 1, 2015.

(51) Int. Cl. G06Q 30/02; H04L 29/08

(52) U.S. Cl. CPC G06Q 30/0263; H04L 67/20; H04L 67/02; H04L 67/22; G06Q 30/0275; G06Q 30/0277

(57) ABSTRACT

Aspects of the present disclosure are presented for a third party content recommendation platform to provide a publisher the ability to target web users, who have visited the publisher's website(s), with the publisher's advertisements when the web user visits other web sites within an affiliated network of the third party content recommendation platform.

### TECHNICAL FIELD

The subject matter disclosed herein generally relates to processing data. In some embodiments, the present disclosures relate to methods and apparatuses for retargeting web users by website publishers within an affiliated content recommendation network the publishers are associated with.

### BACKGROUND

In online digital marketing, a third party content recommendation platform may generally help facilitate advertisements, offered by one or more advertising companies to be displayed in one or more publishers web properties. Generally, it is desirable for the third party content recommendation platform to provide functionality to advertisers that effectively utilize digital advertisements by reaching suitable customer bases. It is desirable to provide more granular ways to target audiences that are more likely to respond positively to digital advertisements.

### BRIEF SUMMARY

Systems, methods, and apparatuses are presented for a third party content recommendation network platform in e-marketing to enable website publishers to identify web users who have previously visited their web properties (e.g., one or more websites) and specifically retarget them when the web users visit other publisher websites in an affiliated content recommendation network of the third party content recommendation platform that the publishers are associated with.

1. In some embodiments, a method for retargeting a web user in online advertising is presented. The method may include: receiving, by a processor of a third party content recommendation platform, an indication that the web user has accessed, through a device of the web user, a website of a first publisher associated with an advertising network of the third party content recommendation platform; based on the accessed website of the first publisher, transmitting, by the processor, an identifier to the device of the web user used to access the website of the first publisher, the identifier configured to be stored in the device and to be accessed by the third party content recommendation platform after the website of the first publisher is no longer accessed by the device of the web user; receiving, by the processor, an indication that the web user has accessed, through the device of the web user, a website of a second publisher associated with the advertising network of the third party content recommendation platform; accessing, by the processor, the identifier in the device of the web user, through the website of the second publisher; determining that the first publisher has enabled a retargeting feature in an advertisement campaign for retargeting users who have accessed the website of the first publisher with advertisements; and causing display, by the processor, of an advertisement of the first publisher in the website of the second publisher, based on determining that the retargeting feature is enabled.

2. In some embodiments, the method may further include transmitting a widget for placement in the website of the first publisher, and wherein the indication that the web user has accessed the website of the first publisher comprises receiving from the widget a widget tag.

3. In some embodiments of the method, the identifier comprises a cookie configured to be accessible by the third party content recommendation platform through all websites associated with the third party content recommendation network when any of said websites are accessed by the device of the web user.

4. In some embodiments, the method may further comprise facilitating generation of the advertisement campaign by the first publisher.

5. In some embodiments, the method may further comprise determining that a third publisher associated with the advertising network of the third party content recommendation platform has also enabled the retargeting feature in a second advertisement campaign for retargeting users who have accessed a website of the third publisher with advertisements.

6. In some embodiments, the method may further comprise conducting an advertisement resolution process to determine if the advertisement of the first publisher is to be displayed in the website of the second publisher instead of an advertisement of the third publisher is to be displayed in the website of the second publisher, based on determining that the first publisher and the third publisher have enabled the retargeting feature.

7. In some embodiments, the resolution process includes a bidding process involving the first publisher and the third publisher performed by the third party platform.

8. In some embodiments, a system of a third party content recommendation platform is presented comprising a memory and a processor. The processor may be configured to perform any of the methods described in examples 1-7.

9. In some embodiments, a computer readable medium having no transitory signals may is presented comprising instructions that, when executed by a processor, cause the processor to perform operations comprising any of the disclosures of examples 1-7.

### BRIEF DESCRIPTION OF THE DRAWINGS

Some embodiments are illustrated by way of example and not limitation in the figures of the accompanying drawings.

FIG. 1 is a network diagram illustrating an example network environment suitable for performing aspects of the present disclosure, according to some embodiments.

FIG. 2 provides an example flowchart for allowing a web user who accesses a website of the publisher who can be later identified using the retargeting functionality presented herein, according to some embodiments.

FIG. 3 provides an example set of code that may be placed into the publisher's website to enable the widget that is configured to identify a web user upon visitation of the website, according to some embodiments.

FIG. 4 shows an example flowchart for a publisher to generate an advertising campaign that utilizes the retargeting functionality according to aspects of the present disclosure.

FIG. 5 provides an example flowchart for the next step in the retargeting process, involving identifying the web user when the web user accesses a different website, according to some embodiments.

FIG. 6 shows a combined view of FIGS. 2 and 5, essentially showing the actions taken by the web user and the retargeting functionality occurring within, according to some embodiments.

FIG. 7 is a block diagram illustrating components of a machine, according to some example embodiments, able to read instructions from a machine-readable medium and perform any one or more of the methodologies discussed herein.

### DETAILED DESCRIPTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. As used in this specification and the appended claims, the singular forms “a,” “an,” and “the” include plural referents unless the context clearly indicates otherwise.

Systems, methods, and apparatuses are presented for a third party content recommendation network platform in e-marketing to enable website publishers to identify web users who have previously visited their web properties (e.g., one or more websites) and specifically retarget them when the web users visit other publisher websites in an affiliated content recommendation network of the third party content recommendation platform that the publishers are associated with.

The third party content recommendation platform may generally help facilitate advertisements, offered by one or more advertising companies (e.g., a specific company advertising its products, or an e-marketing company advertising on behalf of one or more companies offering products) to be displayed in one or more publishers web properties (e.g., websites displaying content, such as CNN.com, blogs, e-commerce websites, etc.). The third party content recommendation platform may allow a publisher to place widgets onto its websites, wherein these widgets include one or more advertisements and a link directing the user to another website associated with the advertisement. In some cases, the publisher also has interests in advertising its own content or other related products, and therefore can also act as the advertiser to display its own advertisements onto other websites. For example, Walmart may be a publisher that engages web users on its website, Walmart.com. Walmart may also act as an advertiser who wishes to advertise its products in one or more advertisements to direct users to revisit its website when visiting competitor websites, such Target.com. The publisher is likely to increase its chances of generating more web traffic by directing its advertisements to web users who have already visited the publisher's websites, due to already being familiar with the publisher and perhaps even have brand loyalty to the publisher. Furthermore, the publisher's brand can be solidified for the web user if the web user sees multiple instances of the publisher when visiting other websites. Thus, the publisher has an interest in trying to retarget the web users who have already visited its websites, when the web users visit other websites not owned by the publisher.

Conventionally, it is difficult to distinguish between web users who are already familiar with the content of the publisher and those who have not. Rudimentary means for accomplishing this include asking web users to actively sign up to be placed on mailing lists or receive newsletters. However, the vast majority do not wish to actively take the time to place themselves on these lists, particularly since it exposes the web user to additional bombarding of advertising through separate emails and notices, rather than have the advertisements be smoothly embedded into websites that are already expected to show ads. Because of this, publishers who generate advertising campaigns do not have means to specifically and effectively target these web users or at least to differentiate them from others.

Conventionally, retargeting mechanisms in e-commerce and telecommunications are typically performed by brand marketer advertisers, who base their retargeting efforts on a type of product the web user has purchased or at least viewed. For example, if a web user places an item in an Amazon.com virtual shopping cart without purchasing, an advertiser associated with said item may retarget the web user by displaying ads featuring that item or similar products on other websites once the web user leaves Amazon.com. Conventionally, it is the advertiser of a product that conducts retargeting efforts and bases the retargeting on specific products, rather than a publisher who publishes the website.

Aspects of the present disclosure are presented for a third party content recommendation platform to provide a publisher the ability to target web users, who have visited the publisher's website(s), with the publisher's advertisements when the web user visits other web sites within an affiliated network of the third party content recommendation platform. In this way, the publisher increases its ability to leverage its brand by focusing on web users who are known to already be familiar with the publisher's content. This provides the publisher with a higher degree of control over how to best utilize its marketing resources, by focusing on a subgroup of web users more likely to respond to its advertisements. In addition, the third party content recommendation platform may retain and increase its relationship with multiple publishers by incentivizing them to remain within the third party content recommendation network in order to take advantage of the retargeting functionality, and in order to allow the publishers to easily and conveniently re-engage with web users previously shown receptive to its content. Aspects of the present disclosure may provide novel methods for retargeting to occur by retargeting a web user based on what website is visited and the publisher who controls the website, rather than on what product is contemplated and the advertiser associated with the product, as a single product may be found in multiple different websites. In other words, methods and systems are presented for a publisher driven retargeting, rather than conventional advertiser or product driven retargeting.

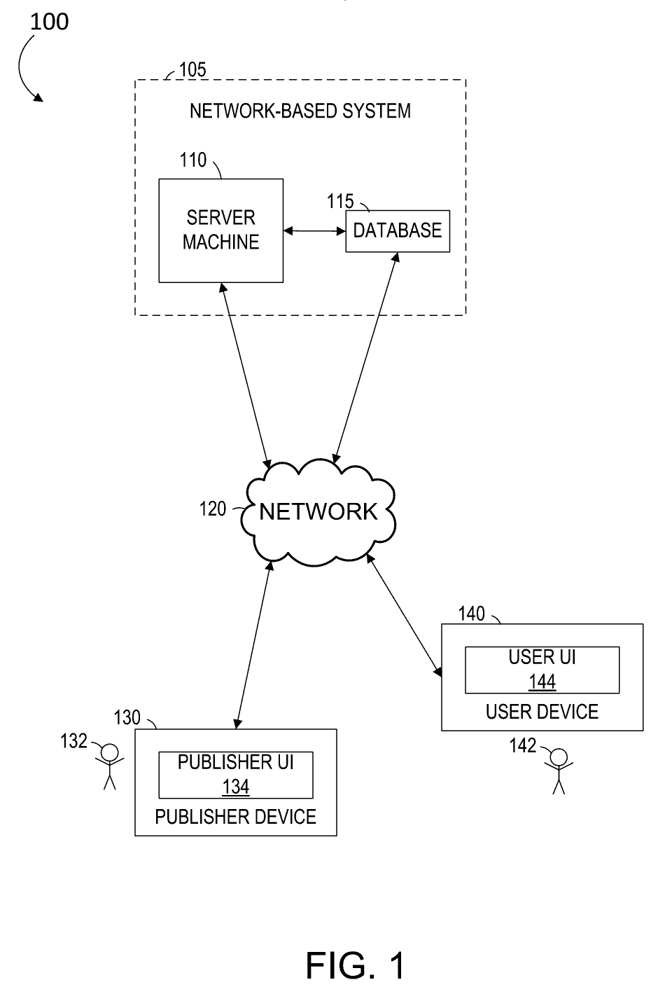

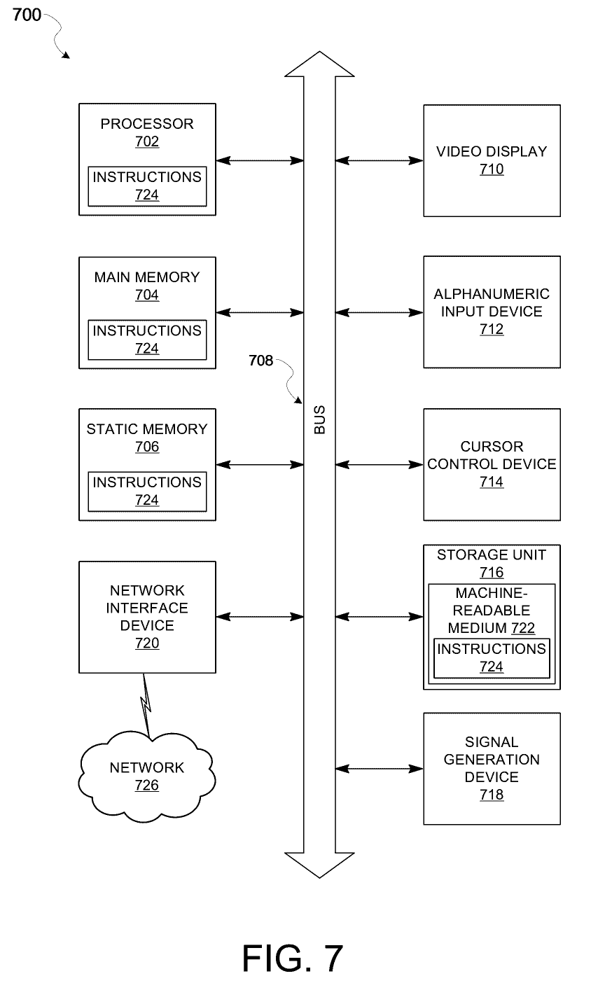

Referring to FIG. 1, a network diagram illustrating an example network environment 100 suitable for performing aspects of the present disclosure is shown, according to some embodiments. The example network environment 100 includes a server machine 110 and a database 115 of a network-based system 105 of a third-party advertising platform, a publisher device 130 for a publisher user 132, and a user device 140 for a user 142 who accesses websites on the Internet, all communicatively coupled to each other via a network 120. The server machine 110 may be implemented by a physical server machine, a virtual server machine, or a combination of the two. may form all or part of a network-based system 105 (e.g., a cloud-based server system configured to provide one or more services to the publisher device 130, user device 140 and publisher device 140). The network-based system 105 may be configured to facilitate advertisement placements by multiple advertisers onto various websites, such as the publisher's 132 websites. In some cases, the publisher 132 also can act as an advertiser, desiring to display advertisements onto other websites in order to direct traffic back to the website(s) of the publisher 132. For purposes of this disclosure, the publisher 132 possesses both one or more websites that displays its own content and advertisements placed by the third party advertisement platform (via the network-based server 105), as well as advertising inclinations to conduct one or more advertising campaigns onto other websites within the third party content recommendation network. The server machine 110, the publisher device 130, and the user device 140 may each be implemented in a computer system, in whole or in part, as described below with respect to FIG. 7.

Also shown in FIG. 1 are the publisher user 132 and the website user 142. One or more of the users 132 and 142 may be a human user, a machine user (e.g., a computer configured by a software program to interact with the publisher device 130), or any suitable combination thereof (e.g., a human assisted by a machine or a machine supervised by a human). The publisher user 132 may be associated with the publisher device 130 and may be a user of the publisher device 130. For example, the publisher device 130 may be a desktop computer, a vehicle computer, a tablet computer, a navigational device, a portable media device, a smartphone, or a wearable device (e.g., a smart watch or smart glasses) belonging to the first user 132. Likewise, the website user 142 may be associated with the user device 140. The publisher user 132 may desire to place advertisements for e-marketing in various websites of other websites that are likely to generate web traffic to associated publisher websites. The user 142 may be an entity that accesses content on a publisher user 132 website, who may be a target audience of the publisher user 132, due to the user 142 visiting the publisher's website and thereby implying that the user 132 has at least some interest in the publisher's content. The publisher user 132 may be an entity who generates one or more websites that provide content for users 142, and who may generate revenue by allowing advertisers to pay for placing their advertisements on the publisher website(s). As previously discussed, the network-based system 105 may be operated by a third-party advertising company that helps facilitate the ad placement of advertisers onto publisher websites.

In some embodiments, the devices 130 and 140 may be configured to display user interfaces that are coupled to the network 120. For example, the publisher device 130 may be configured to display and operate a publisher user interface (UI) 134, and the user device 140 may be configured to display and operate an affiliate UI 144. The Uls 134, and 144 may be configured to receive inputs from a user, such as users 132, and 142, respectively.

Any of the machines, databases 115, publisher device 130, or user device 140 shown in FIG. 1 may be implemented in a general-purpose computer modified (e.g., configured or programmed) by software (e.g., one or more software modules) to be a special-purpose computer to perform one or more of the functions described herein for that machine, database 115, or devices 130, and 140. For example, a computer system able to implement any one or more of the methodologies described herein is discussed below with respect to FIG. 7. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 120 may be any network that enables communication between or among machines, databases 115, and devices (e.g., the server machine 110 and the devices 130, and 140). Accordingly, the network 120 may be a wired network, a wireless network (e.g., a mobile or cellular network), or any suitable combination thereof. The network 120 may include one or more portions that constitute a private network, a public network (e.g., the Internet), or any suitable combination thereof. Accordingly, the network 120 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 120 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

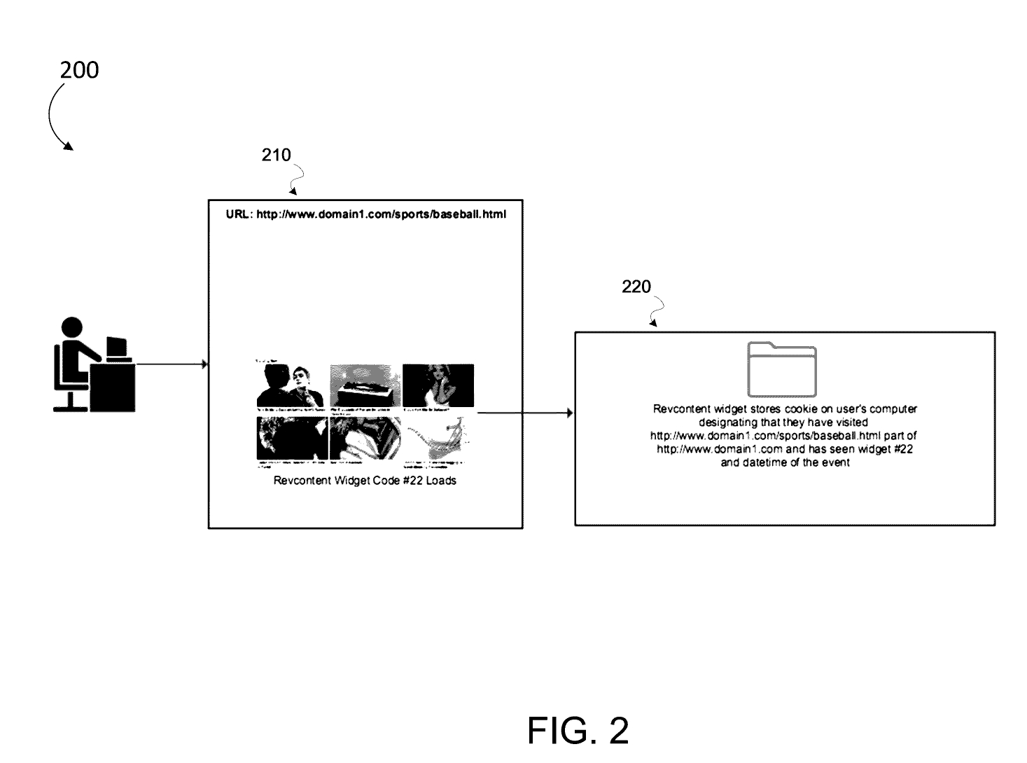

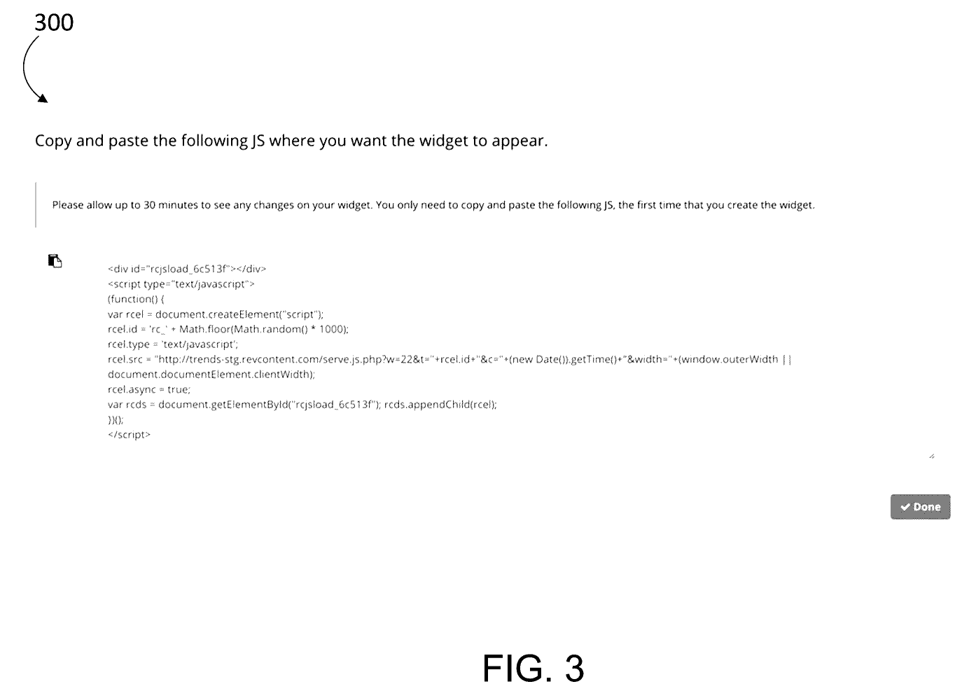

Referring to FIG. 2, illustration 200 provides an example flowchart for allowing a web user, such as user 142, who accesses a website of the publisher, such as publisher user 132, who may then be later identified, according to some embodiments. The process described in illustration 200 represents an initial step in re-targeting the user. Here, for example, the publisher may places a widget on their website, using a widget tag, such as the depicted in FIG. 3, below. The publisher's website is then loaded by the web user, and the widget may store a cookie on the web user's computer to identify the web user as having a history of viewing this website property of the publisher. If the user already has the cookie, nothing is done, in some embodiments.

In this example, the publisher's website includes content about baseball, based on the description of the URL at block 210. The widget #22 as shown in block 210 may be a widget placed by the publisher and provided by the third party content recommendation platform, via networked-based system 105, for example. The widget may provide an advertisement from a different advertiser from the affiliated third party content recommendation network. For example, the widget #22 may provide an advertisement and a link directing the web user to another website related to the advertisement. Typical examples of displays of the widget #22 may be similar to sponsored content sections found at the bottom of content websites, for example.

In addition, at block 220, the widget #22 may automatically store on the web user's computer a cookie or other identifier or tracker that informs the third party content recommendation platform, and by extension, the publisher, that the web user has visited the publisher's website from where the widget #22 was loaded. In some embodiments, the cookie or other identifier may also store other metadata, such as a date and time that the event occurred.

For reference, in some embodiments, the following pseudocode provides example description for the process flow of the example provided in FIG. 2 for initially identifying the web user:

```
{
HTTP Request for Advertising Platform Widget
GET Advertising Platform Retargeting Cookie
If Advertising Platform Retargeting Cookie exists for Domain
  Exit
Else
  SET Advertising Retargeting Cookie for Domain
EndIf
}
```

Referring to FIG. 3, as previously mentioned, illustration 300 provides an example set of code that may be placed into the publisher's website to enable the widget that is configured to identify a web user upon visitation of the website, according to some embodiments. The interface provided in illustration 300 may be a part of the third party content recommendation platform interface that the publisher may access as a member of the affiliated network. In general, the third party content recommendation platform may provide user interfaces to allow the publisher and the advertiser to directly modify their websites with advertising tools, such as the widgets, provided by the third party content recommendation platform, rather than rely on the third party content recommendation company to modify. This may give the publishers and advertisers more control over their content, which may be preferred over other platforms.

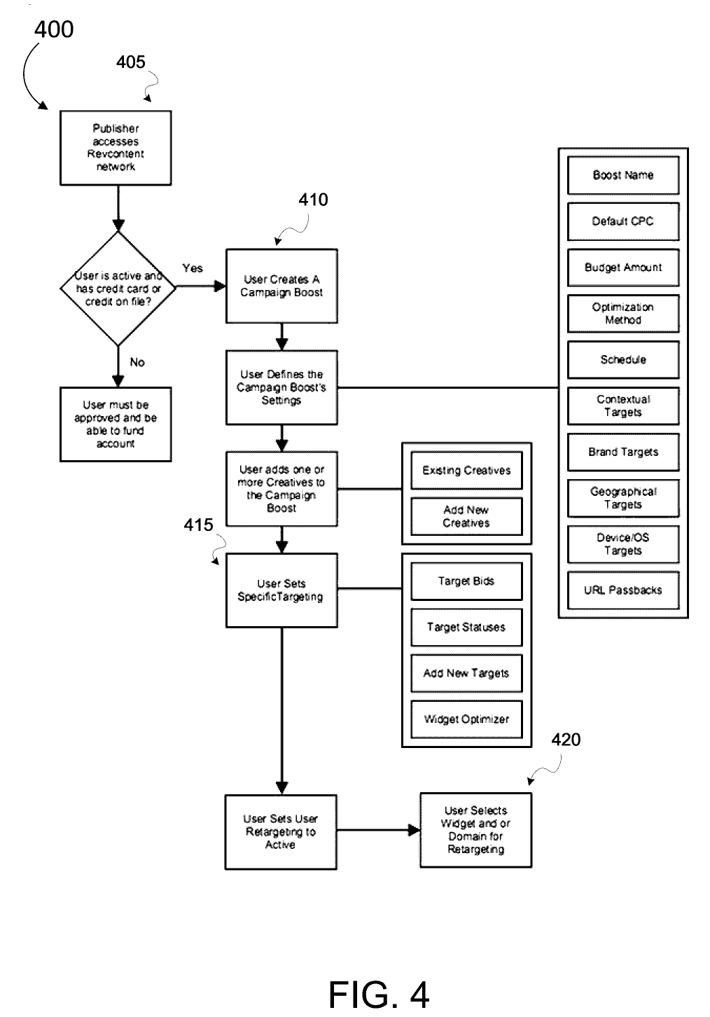

Referring to FIG. 4, illustration 400 shows an example flowchart for a publisher to generate an advertising campaign that utilizes the retargeting functionality according to aspects of the present disclosure. For example, starting at block 405, the publisher may begin the process by logging in to access the third party content recommendation network. Of note, the publisher can be viewed as acting as an advertiser in this case, since the publisher is generating an ad campaign to utilize the retargeting functionality.

At block 410, the publisher may specify a number of campaign boosts that optionally enhance the ad campaign. While there are a number of example boosts that are available, for purposes of this disclosure, at block 415, the publisher user may select specific targeting as one selection of the campaign boosts. In some embodiments, the scope of the specific user targeting may be confined to specific webpages or even specific widgets, while in other cases the scope may be as broad as to include all domains under the control of the publisher (see block 420).

For reference, in some embodiments, the following pseudocode provides example description for the process flow of creating a campaign boost that includes the retargeting functionality, as described in FIG. 4:

}
User creates a Campaign Boost
User defines the campaign boost settings:
boost name, default cpc, budget amount, optimization method, schedule,
contextual targets, brand targets, geographical targets, device/OS targets,
url passbacks
User adds one or more creatives to the campaign boost: add new creative,
select existing creatives
User sets specific targeting: Target bids, target statuses, add new targets,
widget optimizer
User sets User Retargeting to Active or False
If User Retargeting is Active
User selects Domain(s) for which they desire to Target Users from
EndIf
}

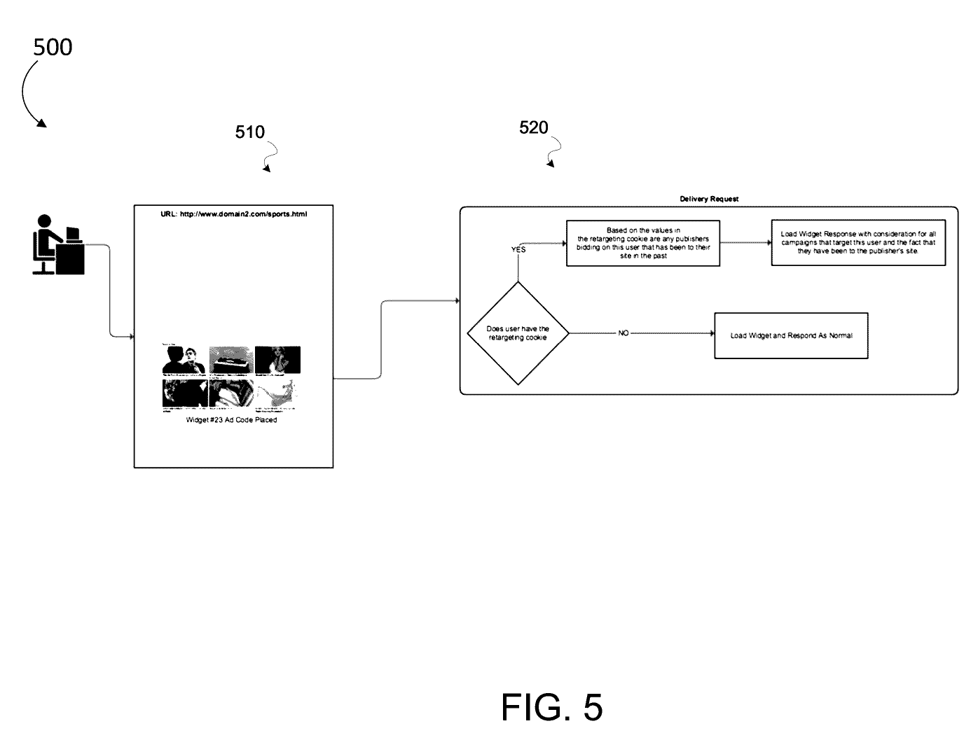

Referring to FIG. 5, illustration 500 provides an example flowchart for the next step in the retargeting process, involving identifying the web user when the web user accesses a different website, according to some embodiments. In some embodiments, the third party content recommendation platform may be configured to perform this process, and may be able to identify web users only when they access websites within the third party content recommendation network. This may be determined by whether the website includes a widget associated with the third party content recommendation platform, for example.

As an example, when this web user browses a different website that contains a widget associated with the third party platform, all cookies associated with the third party platform may be detected. The decision on what advertising content to include for the particular website, for that particular viewing session, may occur in real time. When preparing which content recommendations will then be made for this web user, a lookup is done for any publishers that (1) have created a retargeting campaign and (2) have previously noted that this web user visited the publishers' website(s), thereby allowing their campaign to compete with campaigns that have otherwise entered the possible pool of deliverable ads for the widget. To determine whether the retargeting publishers earn the ability to display their advertisement to the web user on this different website, various conventional processes, such as bidding, may take place. The bidding process may include accessing predetermined bids placed by each of the retargeting publishers. Thus, when a resolution process is needed to determine which retargeting publisher earns the right to target a particular web user, the content recommendation platform may access the predetermined bids by each of the retargeting publishers, determine which bid is the highest, and select the publisher with the highest bid. In the event no bid may be present, the platform may perform an alternative resolution process, such as randomly selecting a qualifying retargeting publisher. Other forms of priority may be considered, such as choosing the retargeting publisher that has paid for the largest campaign, has interacted with the content recommendation platform most recently, or has the most the visitations by the user (e.g., based on number of relevant cookies or search history). If the retargeted campaign qualifies to serve for the impression, then it is used, presenting the user with a creative associated with a website that they have viewed in the past.

Here, and with reference to the previous example in FIG. 2, the web user may access a slightly different website related to sports, in domain 2, at block 510. A different widget #23, also associated with the third party content recommendation platform, may be placed in this website. At block 520, this allows the third party content recommendation platform to access all cookies associated with the third party platform, and may therefore determine that this web user previously accessed the publisher's website related to baseball, in reference to FIG. 2. The third party platform may then determine if the publisher controlling the website about baseball (at block 210 in FIG. 2) is conducting an ad campaign that includes retargeting. If so, the third party platform may include the publisher as at least one of the advertisers vying to include their advertisement into widget #23. If the publisher prevails, its advertisement may then be placed into the website at block 510.

For reference, in some embodiments, the following pseudocode provides example description for the process flow of conducting the retargeting of the web user, as described in FIG. 5:

}
HTTP Request made for Advertising Widget
GET Advertising Retargeting Cookie
If Advertising Retargeting Cookie exists
Foreach Domains as Domain

Get creatives and bids for Retargeting Campaigns for Domain
If creatives allowed to show on widget

Set Creative−>Deliverable Creatives

Endif

endforeach
EndIf
}

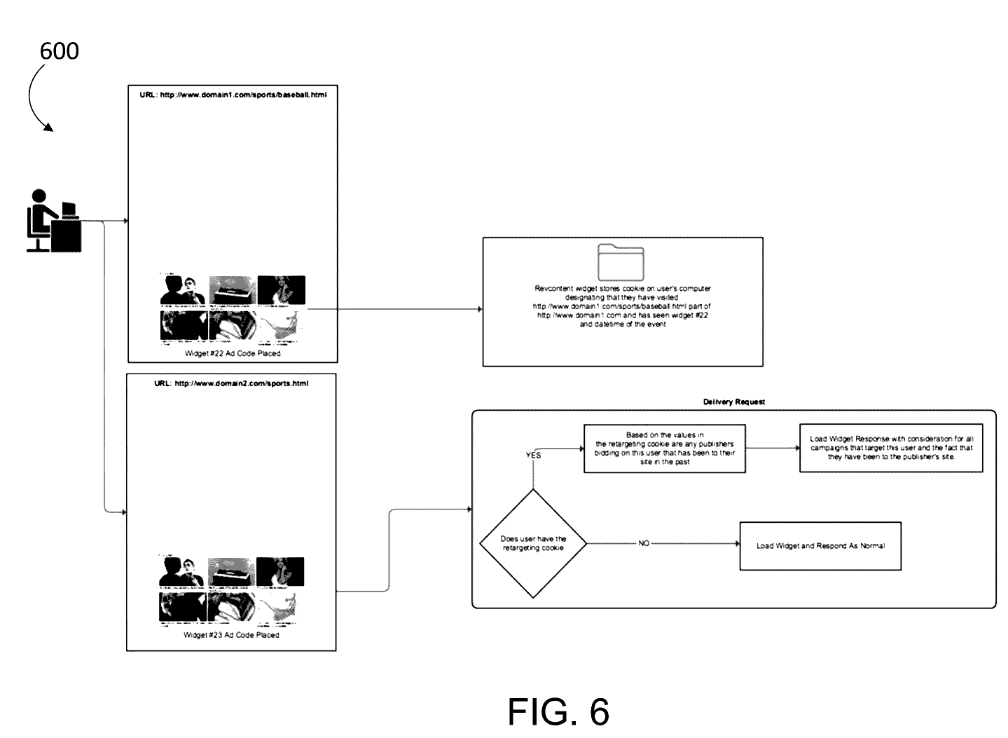

Referring to FIG. 6, illustration 600 shows a combined view of FIGS. 2 and 5, essentially showing the actions taken by the web user and the retargeting functionality occurring within, according to some embodiments. Illustration 600 provides a summarized view of the interplay by the publisher, the third party content recommendation platform, and the user. As previously discussed, the retargeting functionality of the present disclosures may allow for the publishers to better utilize their advertising resources toward those who have demonstrated a greater receptivity to the publisher's website(s). In addition, because some versions of the retargeting functionality rely on accessing websites only within the third party content recommendation network, the multiple publishers may be incentivized to continue using the third party content recommendation platform, rather than a competitor platform.

Referring to FIG. 7, the block diagram illustrates components of a machine 700, according to some example embodiments, able to read instructions 724 from a machine-readable medium 722 (e.g., a non-transitory machine-readable medium, a machine-readable storage medium, a computer-readable storage medium, or any suitable combination thereof) and perform any one or more of the methodologies discussed herein, in whole or in part. Specifically, FIG. 7 shows the machine 700 in the example form of a computer system (e.g., a computer) within which the instructions 724 (e.g., software, a program, an application, an applet, an app, or other executable code) for causing the machine 700 to perform any one or more of the methodologies discussed herein may be executed, in whole or in part.

In alternative embodiments, the machine 700 operates as a standalone device or may be connected (e.g., networked) to other machines. In a networked deployment, the machine 700 may operate in the capacity of a server machine 110 or a client machine in a server-client network environment, or as a peer machine in a distributed (e.g., peer-to-peer) network environment. The machine 700 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 724, sequentially or otherwise, that specify actions to be taken by that machine. Further, while only a single machine 700 is illustrated, the term “machine” shall also be taken to include any collection of machines that individually or jointly execute the instructions 724 to perform all or part of any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a video display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, a signal generation device 718 (e.g., a sound card, an amplifier, a speaker, a headphone jack, or any suitable combination thereof), and a network interface device 720.

The storage unit 716 includes the machine-readable medium 722 (e.g., a tangible and non-transitory machine-readable storage medium) on which are stored the instructions 724 embodying any one or more of the methodologies or functions described herein, including, for example, any of the descriptions of FIGS. 2-6. The instructions 724 may also reside, completely or at least partially, within the main memory 704, within the processor 702 (e.g., within the processor's cache memory), or both, before or during execution thereof by the machine 700. The instructions 724 may also reside in the static memory 706.

Accordingly, the main memory 704 and the processor 702 may be considered machine-readable media 722 (e.g., tangible and non-transitory machine-readable media). The instructions 724 may be transmitted or received over a network 726 via the network interface device 720. For example, the network interface device 720 may communicate the instructions 724 using any one or more transfer protocols (e.g., HTTP). The machine 700 may also represent example means for performing any of the functions described herein, including the processes described in FIGS. 2-6.

In some example embodiments, the machine 700 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 722 able to store data temporarily or permanently and may be taken to include, but not be limited to, random-access memory (RAM), read-only memory (ROM), buffer memory, flash memory, and cache memory. While the machine-readable medium 722 is shown in an example embodiment to be a single medium, the term “machine-readable medium” should be taken to include a single medium or multiple media (e.g., a centralized or distributed database 115, or associated caches and servers) able to store instructions 724. The term “machine-readable medium” shall also be taken to include any medium, or combination of multiple media, that is capable of storing the instructions 724 for execution by the machine 700, such that the instructions 724, when executed by one or more processors of the machine 700 (e.g., processor 702), cause the machine 700 to perform any one or more of the methodologies described herein, in whole or in part. Accordingly, a “machine-readable medium” refers to a single storage apparatus or device such as machines 110, 130, 140, or 150, as well as cloud-based storage systems or storage networks that include multiple storage apparatus or devices such as machines 110, 130, 140 or 150. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 722 is non-transitory in that it does not embody a propagating signal. However, labeling the tangible machine-readable medium 722 as “non-transitory” should not be construed to mean that the medium is incapable of movement; the medium should be considered as being transportable from one physical location to another. Additionally, since the machine-readable medium 722 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 722 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 702 or a group of processors 702) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 702 or other programmable processor 702. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 708) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 702 that are temporarily configured (e.g., by software) or permanently configured to perform the relevant operations. Whether temporarily or permanently configured, such processors 702 may constitute processor-implemented modules that operate to perform one or more operations or functions described herein. As used herein, “processor-implemented module” refers to a hardware module implemented using one or more processors 702.

Similarly, the methods described herein may be at least partially processor-implemented, a processor 702 being an example of hardware. For example, at least some of the operations of a method may be performed by one or more processors 702 or processor-implemented modules. As used herein, “processor-implemented module” refers to a hardware module in which the hardware includes one or more processors 702. Moreover, the one or more processors 702 may also operate to support performance of the relevant operations in a “cloud computing” environment or as a “software as a service” (SaaS). For example, at least some of the operations may be performed by a group of computers (as examples of machines 700 including processors 702), with these operations being accessible via a network 726 (e.g., the Internet) and via one or more appropriate interfaces (e.g., an API).

The performance of certain operations may be distributed among the one or more processors 702, not only residing within a single machine 700, but deployed across a number of machines 700. In some example embodiments, the one or more processors 702 or processor-implemented modules may be located in a single geographic location (e.g., within a home environment, an office environment, or a server farm). In other example embodiments, the one or more processors 702 or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine 700 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A method for retargeting a web user in online advertising, the method comprising:
receiving, by a processor of a third party content recommendation platform, an indication that the web user has accessed, through a device of the web user, a website of a first publisher associated with an advertising network of the third party content recommendation platform;
based on the accessed website of the first publisher, transmitting, by the processor, an identifier to the device of the web user used to access the website of the first publisher, the identifier configured to be stored in the device and to be accessed by the third party content recommendation platform after the website of the first publisher is no longer accessed by the device of the web user;
receiving, by the processor, an indication that the web user has accessed, through the device of the web user, a website of a second publisher associated with the advertising network of the third party content recommendation platform;
accessing, by the processor, the identifier in the device of the web user, through the website of the second publisher;
determining that the first publisher has enabled a retargeting feature in an advertisement campaign for retargeting users who have accessed the website of the first publisher with advertisements; and
causing display, by the processor, of an advertisement of the first publisher in the website of the second publisher, based on determining that the retargeting feature is enabled.

2. The method of claim 1, further comprising transmitting a widget for placement in the website of the first publisher, and wherein the indication that the web user has accessed the website of the first publisher comprises receiving from the widget a widget tag.

3. The method of claim 1, wherein the identifier comprises a cookie configured to be accessible by the third party content recommendation platform through all websites associated with the third party content recommendation network when any of said websites are accessed by the device of the web user.

4. The method of claim 1, further comprising facilitating generation of the advertisement campaign by the first publisher.

5. The method of claim 1, further comprising determining that a third publisher associated with the advertising network of the third party content recommendation platform has also enabled the retargeting feature in a second advertisement campaign for retargeting users who have accessed a website of the third publisher with advertisements.

6. The method of claim 5, further comprising conducting an advertisement resolution process to determine if the advertisement of the first publisher is to be displayed in the website of the second publisher instead of an advertisement of the third publisher is to be displayed in the website of the second publisher, based on determining that the first publisher and the third publisher have enabled the retargeting feature.

7. The method of claim 6, wherein the resolution process includes a bidding process involving the first publisher and the third publisher performed by the third party platform.

8. A system of a third party content recommendation platform, the system comprising:
a server comprising a processor;
the processor configured to:
receive an indication that a web user has accessed, through a device of a web user, a website of a first publisher associated with an advertising network of the third party content recommendation platform;
based on the accessed website of the first publisher, transmit an identifier to the device of the web user used to access the website of the first publisher, the identifier configured to be stored in the device and to be accessed by the third party content recommendation platform after the website of the first publisher is no longer accessed by the device of the web user;
receive an indication that the web user has accessed, through the device of the web user, a website of a second publisher associated with the advertising network of the third party content recommendation platform;
access the identifier in the device of the web user, through the website of the second publisher;
determine that the first publisher has enabled a retargeting feature in an advertisement campaign for retargeting users who have accessed the website of the first publisher with advertisements; and
cause display of an advertisement of the first publisher in the website of the second publisher, based on conducting the advertisement resolution process.

9. The system of claim 8, wherein the processor is further configured to transmit a widget for placement in the website of the first publisher, and wherein the indication that the web user has accessed the website of the first publisher comprises reception from the widget a widget tag.

10. The system of claim 8, wherein the identifier comprises a cookie configured to be accessible by the third party content recommendation platform through all websites associated with the third party content recommendation network when any of said websites are accessed by the device of the web user.

11. The system of claim 8, wherein the processor is further configured to facilitate generation of the advertisement campaign by the first publisher.

12. The system of claim 8, wherein the processor is further configured to determine that a third publisher associated with the advertising network of the third party content recommendation platform has also enabled the retargeting feature in a second advertisement campaign for retargeting users who have accessed a website of the third publisher with advertisements.

13. The system of claim 12, wherein the processor is further configured to conduct an advertisement resolution process to determine if the advertisement of the first publisher is to be displayed in the website of the second publisher instead of an advertisement of the third publisher is to be displayed in the website of the second publisher, based on determining that the first publisher and the third publisher have enabled the retargeting feature.

14. The system of claim 13, wherein the resolution process includes a bidding process involving the first publisher and the third publisher performed by the third party platform.

15. A non transitory computer readable medium comprising instructions that, when interpreted by a processor, cause a machine to perform operations comprising:
receiving an indication that a web user has accessed, through a device of the web user, a website of a first publisher associated with an advertising network of a third party content recommendation platform;
based on the accessed website of the first publisher, transmitting an identifier to the device of the web user used to access the website of the first publisher, the identifier configured to be stored in the device and to be accessed by the third party content recommendation platform after the website of the first publisher is no longer accessed by the device of the web user;
receiving an indication that the web user has accessed, through the device of the web user, a website of a second publisher associated with the advertising network of the third party content recommendation platform;
accessing the identifier in the device of the web user, through the website of the second publisher;
determining that the first publisher has enabled a retargeting feature in an advertisement campaign for retargeting users who have accessed the website of the first publisher with advertisements; and
causing display of an advertisement of the first publisher in the website of the second publisher, based on conducting the advertisement resolution process.

16. The computer readable medium of claim 15, wherein the operations further comprise transmitting a widget for placement in the website of the first publisher, and wherein the indication that the web user has accessed the website of the first publisher comprises receiving from the widget a widget tag.

17. The computer readable medium of claim 15, wherein the identifier comprises a cookie configured to be accessible by the third party content recommendation platform through all websites associated with the third party content recommendation network when any of said websites are accessed by the device of the web user.

18. The computer readable medium of claim 15, wherein the operations further comprise facilitating generation of the advertisement campaign by the first publisher.

19. The computer readable medium of claim 15, wherein the operations further comprise determining that a third publisher associated with the advertising network of the third party content recommendation platform has also enabled the retargeting feature in a second advertisement campaign for retargeting users who have accessed a website of the third publisher with advertisements.

20. The computer readable medium of claim 19, wherein the operations further comprise conducting an advertisement resolution process to determine if the advertisement of the first publisher is to be displayed in the website of the second publisher instead of an advertisement of the third publisher is to be displayed in the website of the second publisher, based on determining that the first publisher and the third publisher have enabled the retargeting feature.
